(19) United States
(12) Patent Application Publication
(10) Pub. No.: US 2015/0271836 A1
(43) Pub. Date: Sep. 24, 2015

(54) TECHNIQUES FOR BEARER PRIORITIZATION AND DATA MAPPING IN MULTIPLE CONNECTIVITY WIRELESS COMMUNICATIONS

(71) Applicant: QUALCOMM Incorporated, San Diego, CA (US)

(72) Inventors: Jelena Damnjanovic, Del Mar, CA (US); Madhavan Srinivasan Vajapeyam, San Diego, CA (US); Aleksandar Damnjanovic, Del Mar, CA (US)

(21) Appl. No.: 14/592,643

(22) Filed: Jan. 8, 2015

Related U.S. Application Data
(60) Provisional application No. 61/969,012, filed on Mar. 21, 2014.

(51) Int. Cl. H04W 72/10; H04W 72/06; H04W 72/04

(52) U.S. Cl. CPC H04W 72/10; H04W 72/0413; H04W 72/06

(57) ABSTRACT

Certain aspects of the present disclosure relate to mapping bearer data in multiple connectivity configurations. A first portion of first data available for transmission over a first type bearer can be mapped to first uplink resources granted from a first base station, wherein the first type bearer is configured for transmission using the first base station and a second base station. Then, it can be determined whether a remaining portion of the first uplink resources are available after mapping the first portion of first data. If so, second data from a second type bearer can be mapped to at least a first portion of the remaining portion of the first uplink resources based at least in part on determining that the remaining portion of the first uplink resources are available. This can ensure, in some cases, that data for the second type bearer is also transmitted over the uplink resources.

### CLAIM OF PRIORITY UNDER 35 U.S.C. §119

The present application for patent claims priority to Provisional Application No. 61/969,012 entitled “TECHNIQUES FOR MAPPING BEARER PRIORITIZATION AND DATA MAPPING IN MULTIPLE CONNECTIVITY WIRELESS COMMUNICATIONS” filed Mar. 21, 2014, which is assigned to the assignee hereof and hereby expressly incorporated by reference herein.

### FIELD OF THE DISCLOSURE

The present disclosure, for example, relates to wireless communication systems, and more particularly to techniques for mapping data in multiple connectivity wireless communications.

### BACKGROUND OF THE DISCLOSURE

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations (e.g., eNodeBs) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

To improve the performance of wireless communications, it may be desirable to allow a UE to simultaneously communicate with multiple base stations over multiple uplink grants from the base stations, which can be referred to as multiple connectivity, or more specifically, dual connectivity, where the UE communicates over uplink grants from two base stations. Moreover, a plurality of bearers can be configured to facilitate communication between the UE and the wireless network via the multiple base stations, and in some cases, a given bearer may be split to transmit data to a plurality of base stations. This configuration can facilitate using the multiple base stations to provide a certain quality of service (QoS), but can also result in complexities relating to managing communications over the bearer, especially where other bearers exist and are configured with one or more of the base stations and also require at least a certain QoS.

In view of the foregoing, it may be understood that there may be significant problems and shortcomings associated with current designs of multiple connectivity between UEs and eNBs.

### SUMMARY OF THE DISCLOSURE

Aspects of the present disclosure relate generally to wireless communications, and more particularly, to techniques for mapping data to resources in multiple connectivity wireless communications. For example, techniques for mapping data to uplink resource grants from at least two base stations are described herein. In this regard, in multiple connectivity wireless communications, a wireless device may be communicatively connected to at least two base stations (e.g., eNodeBs and/or access points (APs), or a combination thereof).

In accordance with an aspect, a wireless device (e.g., user equipment (UE)) may communicate with multiple base stations (e.g., a master eNodeB (MeNodeB or MeNB) and at least one a secondary eNodeB (SeNodeB or SeNB)) in a wireless network. Multiple bearers may also be configured for the wireless device in communicating in the wireless network via the multiple base stations. For example, the multiple bearers may include a bearer that is configured with a single base station (e.g., using resources from the single base station) and/or a split bearer that is configured with a plurality of base stations (e.g., using resources of multiple base stations). Each of the multiple bearers may have different priorities associated with each of the multiple bearers. For example, a UE may be configured with a first bearer (e.g., a split bearer) with a higher priority than a second bearer (e.g., a single bearer) with a lower priority. In an example, the first bearer (e.g., higher priority) may be served (e.g., mapping first bearer data to transmission resources corresponding to a logical uplink channel) before the second bearer because of higher priority associated with the first bearer. In this example, to ensure a level of quality of service (QoS) for the second bearer to be served (e.g., mapping second bearer data to transmission resources), the wireless device can map a fraction of available data for the first bearer (e.g., split bearer) to the resources of the one of the multiple base stations instead of mapping all available data for the first bearer (e.g., split bearer) over the resources. In an example, the at least a portion of the available data of a first bearer to be mapped may be determined based at least in part on a token bucket algorithm. For example, the at least a portion of the available data of a first bearer to be mapped may be determined based at least in part on a portion of available tokens in a token bucket. In this regard, a remaining portion of resources of the one of the multiple base stations can be used for mapping data of a second bearers.

According to an aspect, a method for bearer prioritization and data mapping in wireless communication is described. The method includes mapping a first portion of first data available for transmission over a first type bearer to first uplink resources granted from a first base station, wherein the first type bearer is configured for transmission using the first base station and a second base station, determining whether a remaining portion of the first uplink resources are available after mapping the first portion of the first data, and mapping second data from a second type bearer to at least a first portion of the remaining portion of the first uplink resources based at least in part on determining that the remaining portion of the first uplink resources are available.

Moreover, for example, the method may also include determining whether a second remaining portion of the first uplink resources are available after mapping the second data; and mapping a second portion of the first data available for transmission over the first type bearer to the first uplink resources based at least in part on determining that the second remaining portion of the first uplink resources are available. The method can also include wherein the mapping the first portion of the first data is based at least in part on utilizing a fraction of available tokens in a token bucket related to the first type bearer. The method may further include wherein the token bucket is a common token bucket utilized in providing a quality of service for the first type bearer over the first uplink resources of the first base station and second uplink resources of the second base station. The method can also include determining the fraction of available tokens based at least in part on a buffer status report fraction for the first type bearer. The method may also include determining the fraction of available tokens based in part on reserving a number of the available tokens for mapping base station specific data for the first base station over the first uplink resources. In addition, for example, the method may include determining the fraction of available tokens based at least in part on respective achievable throughputs over a first link with the first base station and a second link with the second base station. In other aspects, the method may include determining the fraction of available tokens based at least in part on determining that a number of tokens in another token bucket for the second type bearer is above a threshold level. Further, the method may include a second token bucket for utilizing in mapping other data of the first type bearer to second uplink resources granted from the second base station. The method may also include mapping a second portion of the first data to the first uplink resources granted from the first base station based at least in part on utilizing a portion of tokens from the second token bucket. The method may further include wherein utilizing the portion of tokens from the second token bucket comprises ensuring a minimum number of tokens remain in the second token bucket. The method may also include ensuring a minimum number of tokens in the second token bucket when utilizing the portion of the tokens from the second token bucket to facilitate mapping of base station specific data on the uplink resources granted from the second base station. Also, the method may include determining to utilize the portion of tokens in the second token bucket in mapping the second portion of the first data based at least in part on mapping the second data from the second type bearer to the uplink resources granted from the first base station. The method can additionally include transmitting the first portion of the first data and the second data as mapped over the first uplink resources to the first base station. The method may include wherein the first type bearer is of a higher priority than the second type bearer.

In another aspect, an apparatus for bearer prioritization and data mapping in wireless communication is provided. The apparatus includes a split bearer data mapping component configured to map a first portion of first data available for transmission over a first type bearer to first uplink resources granted from a first base station, wherein the first type bearer is configured for transmission using the first base station and a second base station. The apparatus also includes an eNodeB-specific bearer data mapping component configured to determine whether a remaining portion of the first uplink resources are available after mapping the first portion of the first data, and map second data from a second type bearer to at least a first portion of the remaining portion of the first uplink resources based at least in part on determining that the remaining portion of the first uplink resources are available.

The apparatus may include wherein the split bearer data mapping component is further configured to determine whether a second remaining portion of the first uplink resources are available after mapping the second data, and map a second portion of the first data available for transmission over the first type bearer to the first uplink resources based at least in part on determining that the second remaining portion of the first uplink resources are available. The apparatus may further include wherein the split bearer data mapping component is configured to map the first portion of the first data based at least in part on utilizing a fraction of available tokens in a token bucket related to the first type bearer. The apparatus may additionally include wherein the token bucket is a common token bucket utilized in providing a quality of service for the first type bearer over the first uplink resources of the first base station and second uplink resources of the second base station. Further, the apparatus may include wherein the split bearer data mapping component is configured to determine the fraction of available tokens based at least in part on at least one of a buffer status report fraction for the first type bearer, reserving a number of the available tokens for mapping base station specific data for the first base station over the first uplink resources, or respective achievable throughputs over a first link with the first base station and a second link with the second base station. The apparatus may also include wherein the split bearer data mapping component is configured to determine the fraction of available tokens based at least in part on determining that a number of tokens in another token bucket for the second type bearer is above a threshold level. Further, the apparatus may include a second token bucket for utilizing in mapping other data of the first type bearer to second uplink resources granted from the second base station. The apparatus may additionally include wherein the split bearer data mapping component is configured to map a second portion of the first data to the first uplink resources granted from the first base station based at least in part on utilizing a portion of tokens from the second token bucket. Also, the apparatus may include wherein the split bearer data mapping component is configured to utilize the portion of tokens from the second token bucket at least in part by ensuring a minimum number of tokens remain in the second token bucket. Furthermore, the apparatus may include wherein the split bearer data mapping component is configured to utilize the portion of tokens in the second token bucket in mapping the second portion of the first data based at least in part on mapping the second data from the second type bearer to the uplink resources granted from the first base station.

Still, in further aspects, an apparatus for bearer prioritization and data mapping in wireless communication is described that includes means for mapping a first portion of first data available for transmission over a first type bearer to first uplink resources granted from a first base station, wherein the first type bearer is configured for transmission using the first base station and a second base station, means for determining whether a remaining portion of the first uplink resources are available after mapping the first portion of the first data, and means for mapping second data from a second type bearer to at least a first portion of the remaining portion of the first uplink resources based at least in part on determining that the remaining portion of the first uplink resources are available.

The apparatus may also include wherein the means for determining determines whether a second remaining portion of the first uplink resources are available after mapping the second data, and the means for mapping the first portion of the first data maps a second portion of the first data available for transmission over the first type bearer to the first uplink resources based at least in part on determining that the second remaining portion of the first uplink resources are available. Also, the apparatus may include wherein the means for mapping the first portion of the first data maps the first portion of the first data based at least in part on utilizing a fraction of available tokens in a token bucket related to the first type bearer

In additional aspects, a non-transitory computer-readable storage medium are described including code for causing at least one computer to map a first portion of first data available for transmission over a first type bearer to first uplink resources granted from a first base station, wherein the first type bearer is configured for transmission using the first base station and a second base station, code for causing the at least one computer to determine whether a remaining portion of the first uplink resources are available after mapping the first portion of the first data, and code for causing the at least one computer to map second data from a second type bearer to at least a first portion of the remaining portion of the first uplink resources based at least in part on determining that the remaining portion of the first uplink resources are available.

Moreover, the computer-readable medium may include wherein the code for causing the at least one computer to determine determines whether a second remaining portion of the first uplink resources are available after mapping the second data, and the code for causing the at least one computer to map the first portion of the first data maps a second portion of the first data available for transmission over the first type bearer to the first uplink resources based at least in part on determining that the second remaining portion of the first uplink resources are available. The computer-readable medium may also include wherein the code for causing the at least one computer to map the first portion of the first data maps the first portion of the first data based at least in part on utilizing a fraction of available tokens in a token bucket related to the first type bearer.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a wireless communications system, in accordance with an aspect of the present disclosure.

FIG. 2 is a block diagram conceptually illustrating examples of an eNodeB and a UE configured in accordance with an aspect of the present disclosure.

FIG. 3 is a block diagram conceptually illustrating an aggregation of radio access technologies at a UE, in accordance with an aspect of the present disclosure.

FIGS. 4a and 4b are block diagrams conceptually illustrating an example of data paths between a UE and a PDN in accordance with an aspect of the present disclosure.

FIG. 5 is a diagram conceptually illustrating multiple connectivity carrier aggregation in accordance with an aspect of the present disclosure.

FIG. 6 is a block diagram conceptually illustrating an example of a UE and components configured in accordance with an aspect of the present disclosure.

FIG. 7 is a flowchart illustrating an example method for mapping bearer data to uplink resources in accordance with an aspect of the present disclosure.

FIG. 8 is a flowchart illustrating an example method for mapping bearer data to uplink resources using token buckets in accordance with an aspect of the present disclosure.

FIG. 9 is a flowchart illustrating an example method for mapping bearer data to uplink resources using token buckets in accordance with an aspect of the present disclosure.

FIG. 10 is a block diagram conceptually illustrating an example hardware implementation for an apparatus employing a processing system configured in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Various methods, apparatuses, devices, and systems are described for mapping data of multiple bearers to resources related to multiple network entities. In some aspects, a wireless device (e.g., user equipment (UE)) can communicate with the multiple network entities using multiple connectivity, which may include receiving resources for each of the multiple network entities over which the wireless device can communicate in accessing a wireless network. In some aspects of multiple connectivity, a wireless device may be communicatively coupled to a plurality of network entities. For example, a first network entity (e.g., a master eNodeB, also referred to as an MeNodeB or MeNB) may be configured to operate a master cell group (MCG) including one or more cells (e.g., each cell may operate in different frequency bands and may include one or more component carriers (CCs)). A cell in the master cell group (MCG) may be configured as a first primary cell (e.g., PCell_{MCG}) of the master cell group (MCG). A second network entity (e.g., SeNodeB or SeNB) may be configured to operate a secondary cell group (SCG) including one or more cells (e.g., each cell may operate in different frequency bands and may include one or more component carriers (CCs)). A cell in the secondary cell group (SCG) may be designate as a first primary cell (e.g., PCell_{SCG}) of the secondary cell group (SCG). For example, the wireless device may receive configuration information from the first network entity via the first primary cell (e.g., PCell_{MCG}) and configuration information from the second network entity via the second primary cell (e.g., PCell_{SCG}). The first network entity may be non-collocated with the second network entity.

In addition, the wireless device and/or wireless network to which the network entities relate may configure multiple bearers to facilitate communications between the wireless device and the wireless network via the network entities. In one example, the wireless device and/or wireless network can configure a split bearer that can facilitate communication with the wireless network using resources of multiple network entities to provide a quality of service (QoS).

As used herein, “split bearer” can refer to a bearer that is configured between a UE and multiple eNBs. In an example, the split bearer can be managed at a packet data convergence protocol (PDCP) layer by one of the multiple eNBs (e.g., a MeNB). Accordingly, each of the multiple eNBs may have a separate radio link control (RLC) layer, media access control (MAC) layer, etc. associated with the split bearer for communicating with the UE, and the PDCP layer at the one eNB can control receiving/transmitting communications over the lower RLC/MAC layers from the UE at each of the multiple eNBs. The PDCP layer can control the lower layers of the other eNBs by using backhaul connections therewith, for example.

In addition, network entity specific bearers (also referred to herein as eNodeB-specific bearers) can be configured between the wireless device and wireless network using resources of a single network entity. Thus, in some examples, the wireless device may map data from a split bearer and from a network entity specific bearer on resources related to a single network entity. The split bearer can have a different priority than the network entity specific bearer, and, if the split bearer is of higher priority for example, may thus potentially use all or a majority of resources of the network entity, leaving none or an insufficient amount for the network entity specific bearer.

In this regard, in accordance with aspects described herein, the wireless device can select a portion of data related to the higher priority bearer (e.g., a split bearer) for mapping to resources granted by the first base station, which can ensure that at least some of the resources remain for mapping data related to the lower priority bearer (e.g., network entity specific bearer). If resources remain after mapping the data related to the lower priority bearer (e.g., network entity specific bearer), the remaining resources can be used for mapping an additional portion of the data related to the higher priority bearer (e.g., split bearer) if such data remains. As described, in this split bearer configuration, another portion of the data related to the split bearer may be mapped to resources granted by a second base station as well. In a specific example, the wireless device can use a token buckets algorithm for the bearers to provide a QoS. Thus, in this example, the wireless device can utilize a fraction of tokens in a token bucket for the split bearer in determining an amount of data mapped to the resources of the network entity, such to ensure tokens in a token bucket for the network entity specific bearer can be used to determine an amount of data mapped to the resources of the network entity. As described further herein, the token bucket for the split bearer can include separate token buckets for mapping data to resources of each network entity or a common token bucket for mapping data to resources of the network entities to provide the QoS.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of UMTS. 3GPP LTE and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

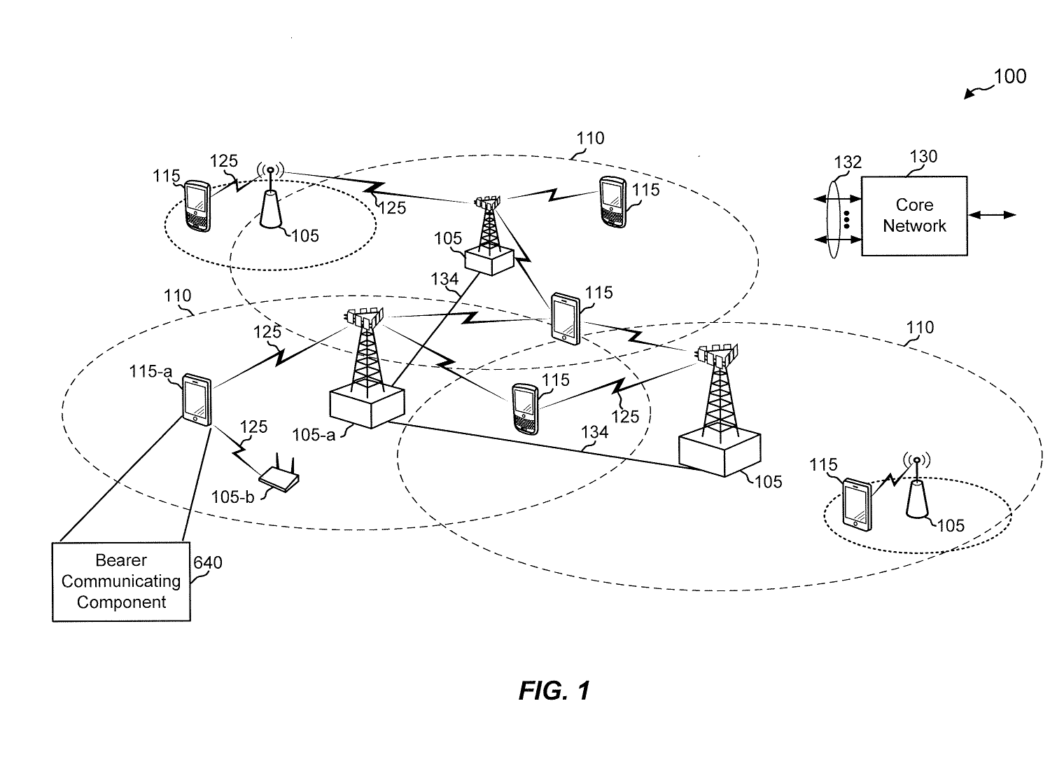

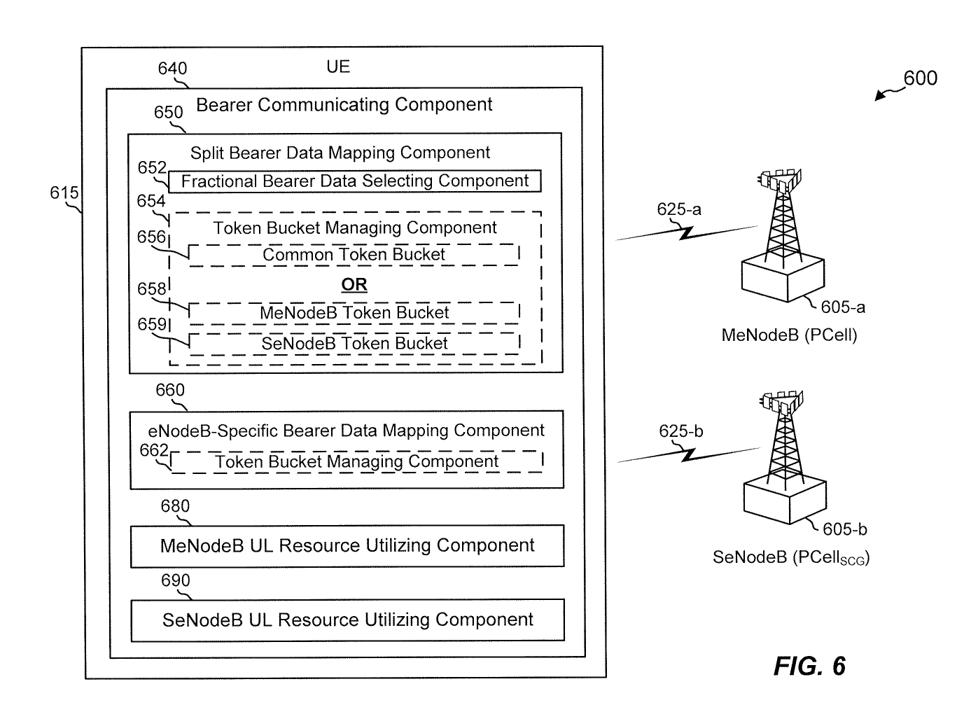

FIG. 1 is a block diagram conceptually illustrating an example of a wireless communications system 100, in accordance with an aspect of the present disclosure. The wireless communications system 100 includes base stations (or cells) 105, user equipment (UEs) 115, and a core network 130. The base stations 105 may communicate with the UEs 115 under the control of a base station controller (not shown), which may be part of the core network 130 or the base stations 105 in various embodiments. For example, the UEs 115 (e.g. UE 115-a and/or other UEs 115) may include a bearer communicating component 640 for determining prioritization of multiple bearers (e.g., split and/or network entity specific bearers) with one or more base stations 105 in mapping data thereto, as described further herein in FIG. 6. The base stations 105 may communicate control information and/or user data with the core network 130 through first backhaul links 132. In embodiments, the base stations 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. The wireless communications system 100 may also support operation on multiple flows at the same time. In some aspects, the multiple flows may correspond to multiple wireless wide area networks (WWANs) or cellular flows. In other aspects, the multiple flows may correspond to a combination of WWANs or cellular flows and wireless local area networks (WLANs) or Wi-Fi flows.

The base stations 105 may wirelessly communicate with the UEs 115 via one or more base station antennas. Each of the base stations 105 sites may provide communication coverage for a respective geographic coverage area 110. In some embodiments, base stations 105 may be referred to as a base transceiver station, a radio base station, an access point, a radio transceiver, a basic service set (BSS), an extended service set (ESS), a NodeB, eNodeB, Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro, micro, and/or pico base stations). There may be overlapping coverage areas for different technologies.

In implementations, the wireless communications system 100 is an LTE/LTE-A network communication system. In LTE/LTE-A network communication systems, the terms evolved Node B (eNodeB) may be generally used to describe the base stations 105. The wireless communications system 100 may be a Heterogeneous LTE/LTE-A network in which different types of eNodeBs provide coverage for various geographical regions. For example, each eNodeB 105 may provide communication coverage for a macro cell, a pico cell, a femto cell, and/or other types of cell. A macro cell generally covers a relatively large geographic area (e.g., several kilometers in radius) and may allow unrestricted access by UEs 115 with service subscriptions with the network provider. A pico cell would generally cover a relatively smaller geographic area (e.g., buildings) and may allow unrestricted access by UEs 115 with service subscriptions with the network provider. A femto cell would also generally cover a relatively small geographic area (e.g., a home) and, in addition to unrestricted access, may also provide restricted access by UEs 115 having an association with the femto cell (e.g., UEs 115 in a closed subscriber group (CSG), UEs 115 for users in the home, and the like). An eNodeB 105 for a macro cell may be referred to as a macro eNodeB. An eNodeB 105 for a pico cell may be referred to as a pico eNodeB. And, an eNodeB 105 for a femto cell may be referred to as a femto eNodeB or a home eNodeB. An eNodeB 105 may support one or multiple (e.g., two, three, four, and the like) cells. The wireless communications system 100 may support use of LTE and WLAN or Wi-Fi by one or more of the UEs 115.

The core network 130 may communicate with the eNodeBs 105 or other base stations 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro eNodeBs, pico eNodeBs, femto eNodeBs, relays, and the like.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

In certain aspects of the wireless communications system 100, a UE 115 may be configured to support carrier aggregation (CA) with two or more eNodeBs 105. The eNodeBs 105 that are used for carrier aggregation may be collocated or may be connected through fast connections. In either case, coordinating the aggregation of component carriers (CCs) for wireless communications between the UE 115 and the eNodeBs 105 may be carried out more easily because information can be readily shared between the various cells being used to perform the carrier aggregation. When the eNodeBs 105 that are used for carrier aggregation are non-collocated (e.g., far apart or do not have a high-speed connection between them), then coordinating the aggregation of component carriers may involve additional aspects. For example, in carrier aggregation for dual connectivity (e.g., UE 115 connected to two non-collocated eNodeBs 105), the UE 115 may receive configuration information to communicate with a first eNodeB 105 (e.g., SeNodeB or SeNB) through a primary cell of the first eNodeB 105. The first eNodeB 105 may include a group of cells referred to as a secondary cell group or SCG, which includes one or more secondary cells and the primary cell or PCell_{SCG} of the first eNodeB 105. The UE 115 may also receive configuration information to communicate with a second eNodeB 105 (e.g., MeNodeB or MeNB) through a second primary cell of the second eNodeB 105. The second eNodeB 105 may include a group of cells referred to as a master cell group or MCG, which includes one or more secondary cells and the primary cell or PCell of the second eNodeB 105.

In certain aspects of the wireless communications system 100, carrier aggregation for dual connectivity may involve having a secondary eNodeB 105 (e.g., SeNodeB or SeNB) be configured to operate one of its cells as a PCell_{SCG}. The secondary eNodeB 105 may transmit, to a UE 115, configuration information through the PCell_{SCG} for the UE 115 to communicate with the secondary eNodeB 105 while the UE 115 is in communication with a master eNodeB 105 (e.g., MeNodeB or MeNB). The master eNodeB 105 may transmit, to the same UE 115, configuration information via its PCell for that UE 115 to communicate with the other eNodeB 105. The two eNodeBs 105 may be non-collocated.

In examples described herein, a UE 115 may communicate with multiple non-collocated eNodeBs 105 over resources granted to the UE 115 by the multiple eNodeBs 105. The UE 115 may have established at least a split bearer and an eNodeB-specific bearer with the core network 130, where the split bearer can correspond to multiple eNodeBs 105, and the eNodeB-specific bearer can correspond to one of the multiple eNodeBs 105. In this example, UE 115 can include a bearer communicating component 640 for mapping data from the bearers over resources granted by the multiple eNodeBs 105, as described herein, such to ensure the eNodeB-specific bearer can use at least a portion of the resources of the related eNodeB 105.

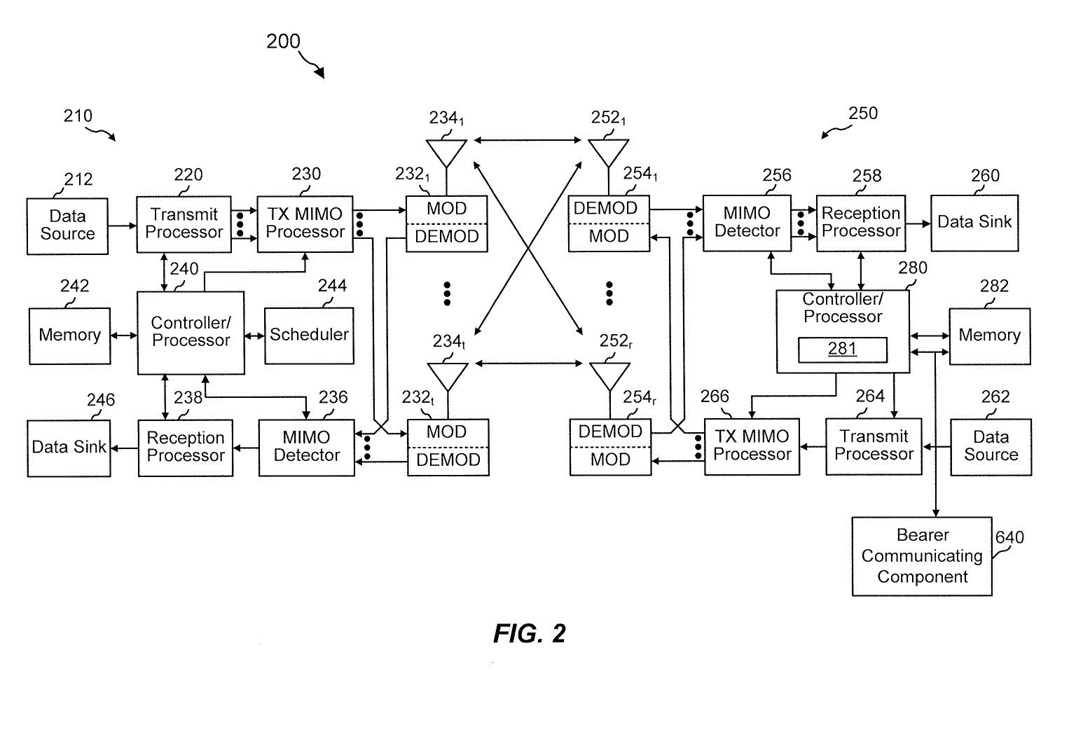

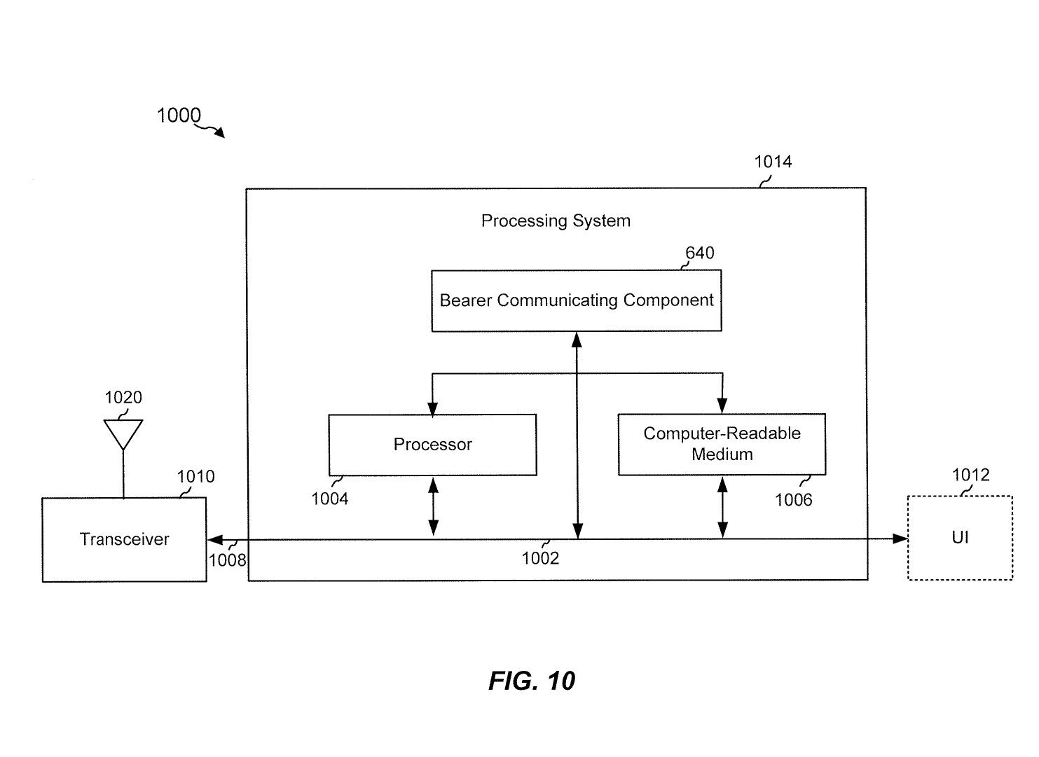

FIG. 2 is a block diagram conceptually illustrating examples of an eNodeB 210 and a UE 250 configured in accordance with an aspect of the present disclosure. For example, the base station/eNodeB 210 and the UE 250 of a system 200, as shown in FIG. 2, may be one of the base stations/eNodeBs and one of the UEs in FIG. 1, 3, 4a, 4b, 5, or 6, respectively, processing system 1014 in FIG. 10, etc. For example, UE 250 may include a bearer communicating component 640, which may be coupled to and/or provided by a controller/processor 280, memory 282, etc., for determining prioritization of multiple bearers (e.g., split and/or network entity specific bearers) with one or more base stations (e.g., eNodeB 210) in mapping data thereto, as described further herein in FIG. 6. In some aspects, the eNodeB 210 may support multiple connectivity (e.g., dual connectivity) carrier aggregation. The eNodeB 210 may be an MeNodeB or MeNB having one of the cells in its MCG configured as a PCell or an SeNodeB or SeNB having one of its cells in its SCG configured as a PCell_{SCG}. In some aspects, the UE 250 may also support multiple connectivity carrier aggregation. The UE 250 may receive configuration information from the eNodeB 210 via the PCell and/or the PCell_{SCG}. The base station 210 may be equipped with antennas 234₁₋ₜ, and the UE 250 may be equipped with antennas 252₁₋ᵣ, wherein t and r are integers greater than or equal to one.

At the base station 210, a base station transmit processor 220 may receive data from a base station data source 212 and control information from a base station controller/processor 240. The control information may be carried on the physical broadcast channel (PBCH), physical control format indicator channel (PCFICH), physical hybrid automatic repeat/request (HARQ) indicator channel (PHICH), physical downlink control channel (PDCCH), etc. (e.g., in LTE). The data may be carried on the physical downlink shared channel (PDSCH), etc. (e.g., in LTE). The base station transmit processor 220 may process (e.g., encode and symbol map) the data and control information to obtain data symbols and control symbols, respectively. The base station transmit processor 220 may also generate reference symbols, e.g., for the primary synchronization signal (PSS), secondary synchronization signal (SSS), and cell-specific reference signal (RS). A base station transmit (TX) multiple-input multiple-output (MIMO) processor 230 may perform spatial processing (e.g., precoding) on the data symbols, the control symbols, and/or the reference symbols, if applicable, and may provide output symbol streams to the base station modulators/demodulators (MODs/DEMODs) 232₁₋ₜ. Each base station modulator/demodulator 232 may process a respective output symbol stream (e.g., for OFDM, etc.) to obtain an output sample stream. Each base station modulator/demodulator 232 may further process (e.g., convert to analog, amplify, filter, and upconvert) the output sample stream to obtain a downlink signal. Downlink signals from modulators/demodulators 232₁₋ₜ may be transmitted via the antennas 234₁₋ₜ, respectively.

At the UE 250, the UE antennas 252₁₋ᵣ may receive the downlink signals from the base station 210 and may provide received signals to the UE modulators/demodulators (MODs/DEMODs) 254₁₋ᵣ, respectively. Each UE modulator/demodulator 254 may condition (e.g., filter, amplify, downconvert, and digitize) a respective received signal to obtain input samples. Each UE modulator/demodulator 254 may further process the input samples (e.g., for OFDM, etc.) to obtain received symbols. A UE MIMO detector 256 may obtain received symbols from all the UE modulators/demodulators 254₁₋ᵣ, and perform MIMO detection on the received symbols if applicable, and provide detected symbols. A UE reception processor 258 may process (e.g., demodulate, deinterleave, and decode) the detected symbols, provide decoded data for the UE 250 to a UE data sink 260, and provide decoded control information to a UE controller/processor 280.

On the uplink, at the UE 250, a UE transmit processor 264 may receive and process data (e.g., for the physical uplink shared channel (PUSCH)) from a UE data source 262 and control information (e.g., for the physical uplink control channel (PUCCH)) from the UE controller/processor 280. The UE transmit processor 264 may also generate reference symbols for a reference signal. The symbols from the UE transmit processor 264 may be precoded by a UE TX MIMO processor 266 if applicable, further processed by the UE modulator/demodulators 254₁₋ᵣ (e.g., for SC-FDM, etc.), and transmitted to the base station 210. At the base station 210, the uplink signals from the UE 250 may be received by the base station antennas 234, processed by the base station modulators/demodulators 232, detected by a base station MIMO detector 236 if applicable, and further processed by a base station reception processor 238 to obtain decoded data and control information sent by the UE 250. The base station reception processor 238 may provide the decoded data to a base station data sink 246 and the decoded control information to the base station controller/processor 240.

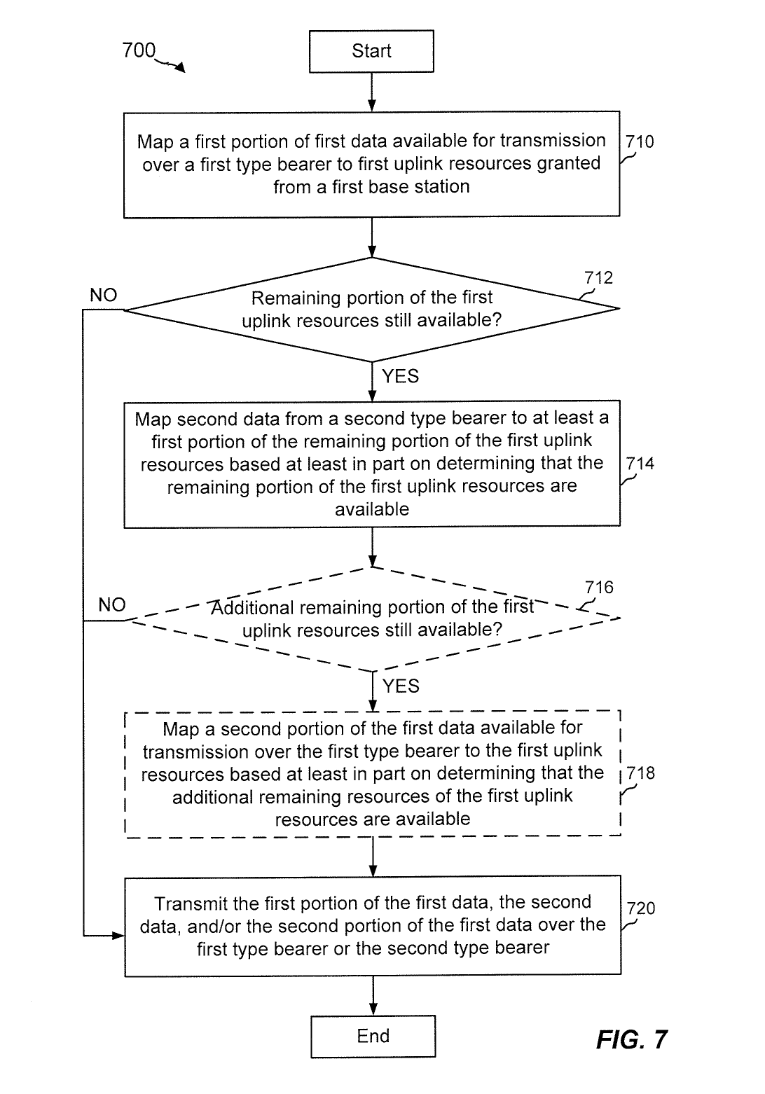

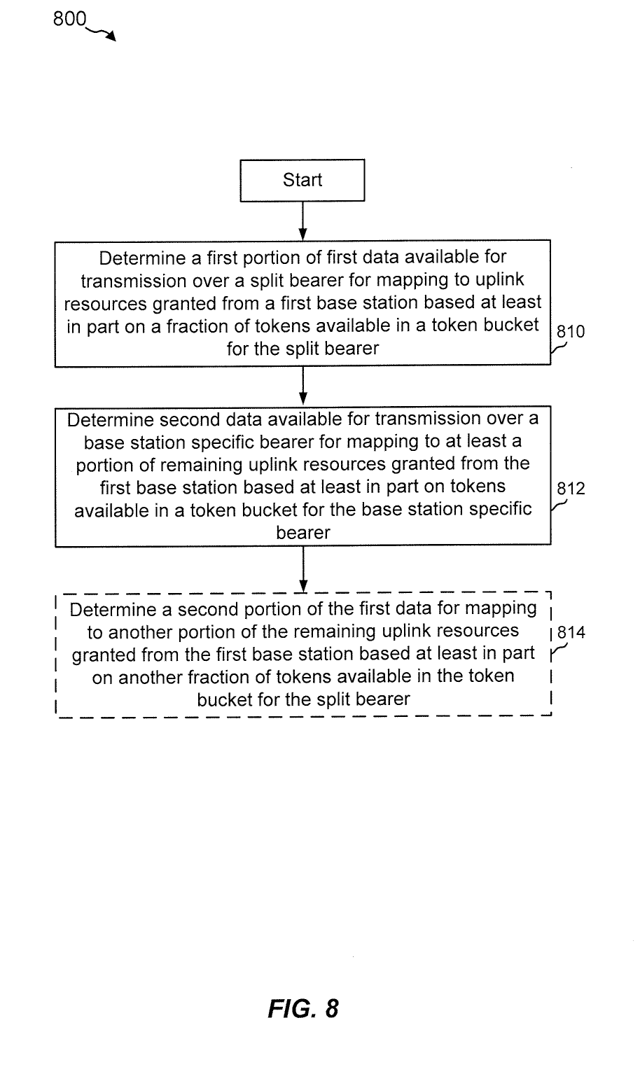

The base station controller/processor 240 and the UE controller/processor 280 may direct the operation at the base station 210 and the UE 250, respectively. The UE controller/processor 280 and/or other processors and modules at the UE 250 may also perform or direct, e.g., the execution of the functional blocks illustrated in FIG. 6, and/or other processes for the techniques described herein (e.g., flowcharts illustrated in FIGS. 7 and 8). In some aspects, at least a portion of the execution of these functional blocks and/or processes may be performed by block 281 in the UE controller/processor 280. The functional blocks may be represented by blocks of bearer communicating component 640, functions performed by the blocks as described in methods 700 and/or 800, etc., for example. The base station memory 242 and the UE memory 282 may store data and program codes for the base station 210 and the UE 250, respectively. For example, the UE memory 282 may store configuration information for multiple connectivity provided by the base station 210 and/or another base station, information related to, or instructions for performing functions of, bearer communicating component 640, etc. A scheduler 244 may be used to schedule UE 250 for data transmission on the downlink and/or uplink.

In one configuration, the UE 250 may include means for mapping a first portion of first data available for transmission over a first type bearer to first uplink resources granted from a first base station, wherein the first type bearer is configured for transmission using the first base station and a second base station. The UE 250 may also include means for determining whether a remaining portion of the first uplink resources are available after mapping the first portion of the first data. The UE 250 may further include means for mapping second data from a second type bearer to at least a first portion of the remaining portion of the first uplink resources based at least in part on determining that the remaining portion of the first uplink resources are available. In one aspect, the aforementioned means may be the UE controller/processor 280, the UE memory 282, the UE reception processor 258, the UE MIMO detector 256, the UE modulators/demodulators 254, and the UE antennas 252 configured to perform the functions recited by the aforementioned means. In another aspect, the aforementioned means may be a module, component, or any apparatus configured to perform the functions recited by the aforementioned means. Examples of such modules, components, or apparatus may be described with respect to FIG. 6 (e.g., bearer communicating component 640 and/or related components).

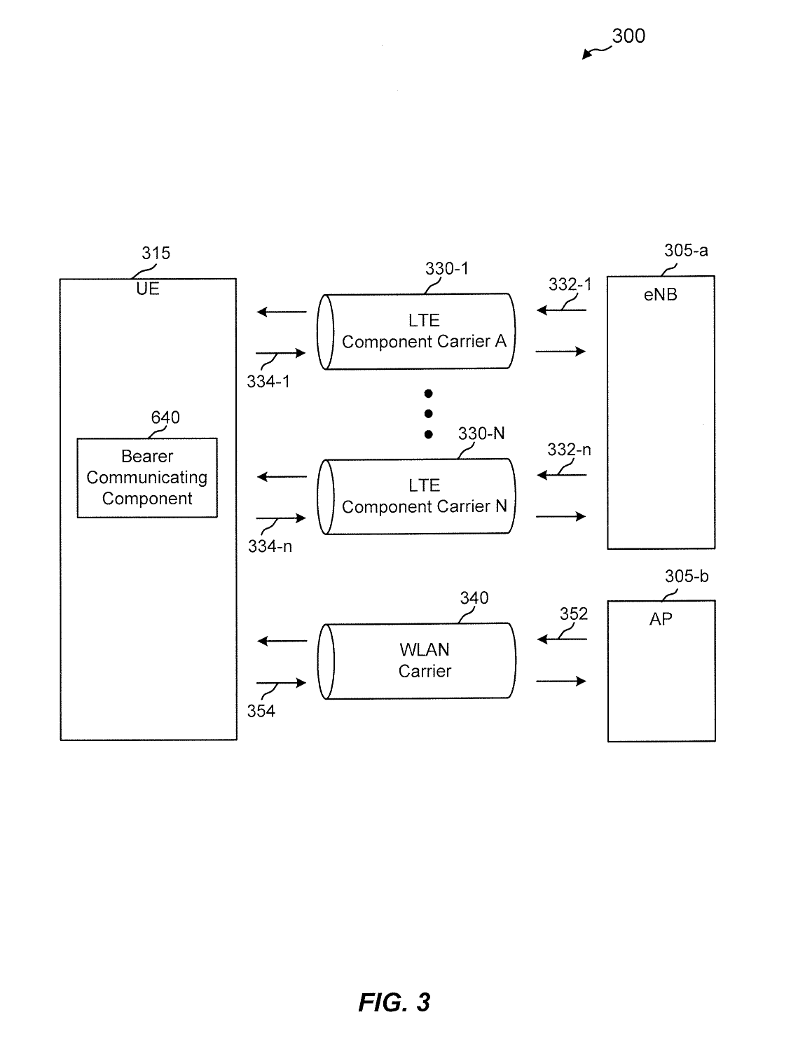

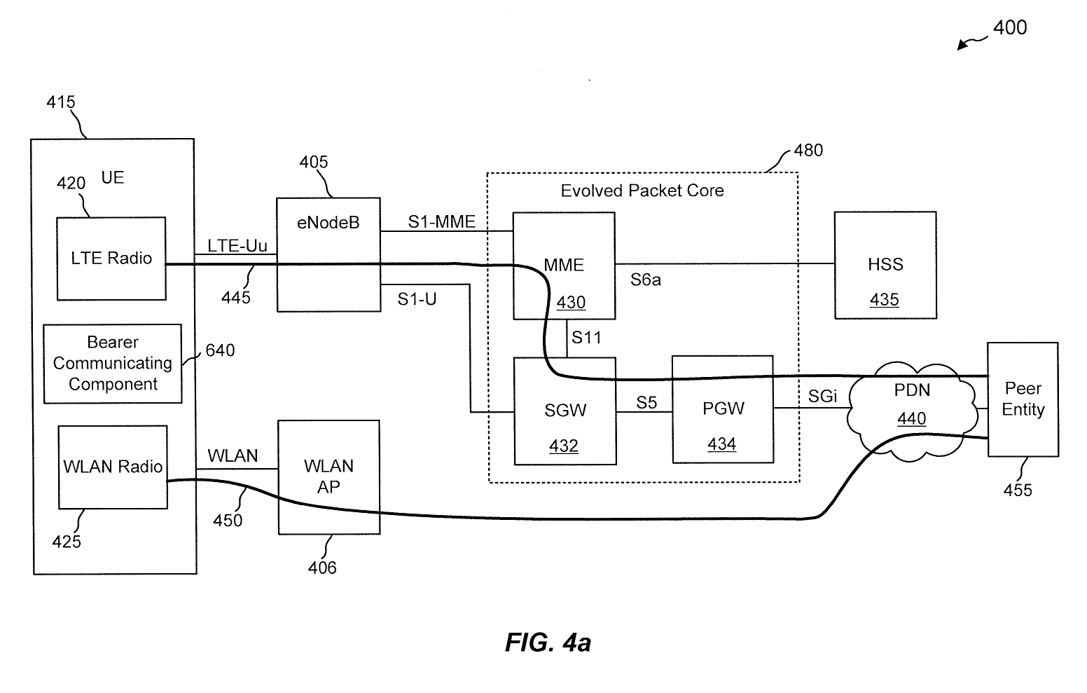

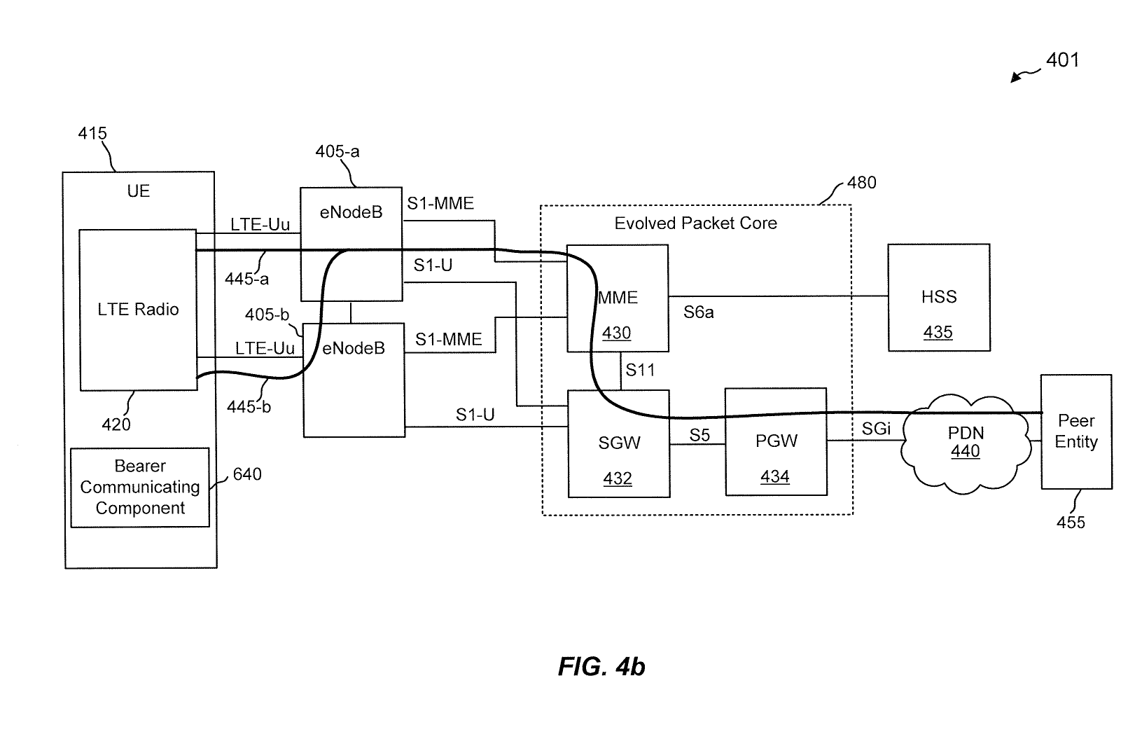

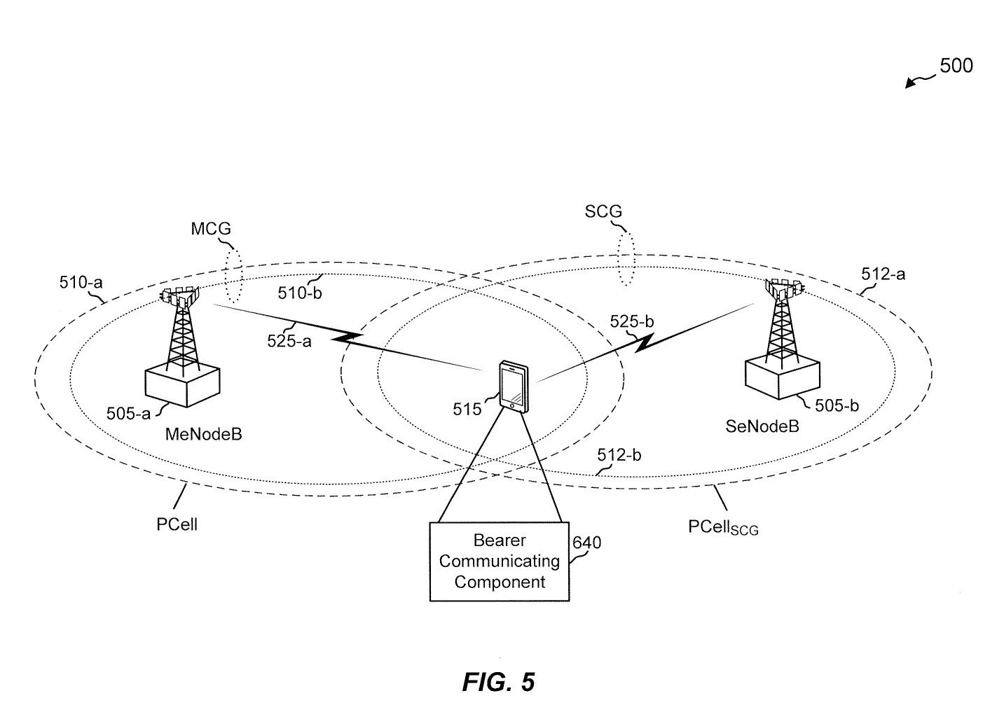

FIG. 3 is a block diagram conceptually an aggregation of radio access technologies at a UE, in accordance with an aspect of the present disclosure. The aggregation may occur in a system 300 including a multi-mode UE 315, which can communicate with an eNodeB 305-a using one or more component carriers 1 through N (CC₁-CC_{N}), and/or with a WLAN access point (AP) 305-b using WLAN carrier 340. For example, UE 315 may include a bearer communicating component 640 for determining prioritization of multiple bearers (e.g., split and/or network entity specific bearers) over one or more CCs 330 or 340 with one or more access points (e.g., eNB 305-a, AP 305-b, etc.) in mapping data thereto, as described further herein in FIG. 6. A multi-mode UE in this example may refer to a UE that supports more than one radio access technology (RAT). For example, the UE 315 supports at least a WWAN radio access technology (e.g., LTE) and a WLAN radio access technology (e.g., Wi-Fi). A multi-mode UE may also support multiple connectivity carrier aggregation as described herein. The UE 315 may be an example of one of the UEs of FIG. 1, FIG. 2, FIG. 3, FIG. 4a, FIG. 4b, FIG. 5, FIG. 6, processing system 1014 in FIG. 10, etc. The eNodeB 305-a may be an example of one of the eNodeBs or base stations of FIG. 1, FIG. 2, FIG. 3, FIG. 4a, FIG. 4b, FIG. 5, FIG. 6. While only one UE 315, one eNodeB 305-a, and one AP 305-b are illustrated in FIG. 3, it will be appreciated that the system 300 can include any number of UEs 315, eNodeBs 305-a, and/or APs 305-b. In one specific example, UE 315 can communicate with one eNB 305 over one LTE component carrier 330 while communicating with another eNB 305 over another component carrier 330.

The eNodeB 305-a can transmit information to the UE 315 over forward (downlink) channels 332-1 through 332-N on LTE component carriers CC₁ through CC_{N} 330. In addition, the UE 315 can transmit information to the eNodeB 305-a over reverse (uplink) channels 334-1 through 334-N on LTE component carriers CC₁ through CC_{N}. Similarly, the AP 305-b may transmit information to the UE 315 over forward (downlink) channel 352 on WLAN carrier 340. In addition, the UE 315 may transmit information to the AP 305-b over reverse (uplink) channel 354 of WLAN carrier 340.

In describing the various entities of FIG. 3, as well as other figures associated with some of the disclosed embodiments, for the purposes of explanation, the nomenclature associated with a 3GPP LTE or LTE-A wireless network is used. However, it is to be appreciated that the system 300 can operate in other networks such as, but not limited to, an OFDMA wireless network, a CDMA network, a 3GPP2 CDMA2000 network and the like.

In multi-carrier operations, the downlink control information (DCI) messages associated with different UEs 315 can be carried on multiple component carriers. For example, the DCI on a PDCCH can be included on the same component carrier that is configured to be used by a UE 315 for PDSCH transmissions (e.g., same-carrier signaling). Alternatively, or additionally, the DCI may be carried on a component carrier different from the target component carrier used for PDSCH transmissions (e.g., cross-carrier signaling). In some implementations, a carrier indicator field (CIF), which may be semi-statically enabled, may be included in some or all DCI formats to facilitate the transmission of PDCCH control signaling from a carrier other than the target carrier for PDSCH transmissions (cross-carrier signaling).

In the present example, the UE 315 may receive data from one eNodeB 305-a. However, users on a cell edge may experience high inter-cell interference which may limit the data rates. Multiflow allows UEs to receive data from two eNodeBs 305-a simultaneously. In some aspects, the two eNodeBs 305-a may be non-collocated and may be configured to support multiple connectivity carrier aggregation. Multiflow works by sending and receiving data from the two eNodeBs 305-a in two totally separate streams when a UE is in range of two cell towers in two adjacent cells at the same time (see FIG. 5 below). The UE talks to two eNodeB 305-a simultaneously when the device is on the edge of either eNodeBs' reach. By scheduling two independent data streams to the mobile device from two different eNodeBs at the same time, multiflow exploits uneven loading in HSPA networks. This can improve the cell edge user experience while increasing network capacity. In one example, throughput data speeds for users at a cell edge may double. In some aspects, multiflow may also refer to the ability of a UE to talk to a WWAN tower (e.g., cellular tower) and a WLAN tower (e.g., AP) simultaneously when the UE is within the reach of both towers. In such cases, the towers may be configured to support carrier aggregation through multiple connections when the towers are not collocated. Multiflow is a feature of LTE/LTE-A that is similar to dual-carrier HSPA, however, there are differences. For example, dual-carrier HSPA may not allow for connectivity to multiple towers to connect simultaneously to a device.

Previously, in LTE-A standardization, LTE component carriers 330 have been backward-compatible, which enabled a smooth transition to new releases. However, this feature caused the LTE component carriers 330 to continuously transmit common reference signals (CRS, also referred to as cell-specific reference signals) in every subframe across the bandwidth. Most cell site energy consumption is caused by the power amplifier, as the cell remains on even when only limited control signaling is being transmitted, causing the amplifier to continue to consume energy. CRS were introduced in release 8 of LTE as a basic downlink reference signal. The CRSs can be transmitted in every resource block in the frequency domain and in every downlink subframe. CRS in a cell can be for one, two, or four corresponding antenna ports. CRS may be used by remote terminals to estimate channels for coherent demodulation. A New Carrier Type (NCT) allows temporarily switching off of cells by removing transmission of CRS in four out of five sub frames, for example. This feature reduces power consumed by the power amplifier, as well as the overhead and interference from CRS, as the CRS is no longer continuously transmitted in every subframe across the bandwidth. In addition, the New Carrier Type allows the downlink control channels to be operated using UE-specific Demodulation Reference Symbols. The New Carrier Type might be operated as a kind of extension carrier along with another LTE/LTE-A carrier or alternatively as standalone non-backward compatible carrier.

FIG. 4a is a block diagram conceptually illustrating an example of data paths 445 and 450 between a UE 415 and a PDN 440 (e.g., Internet or one or more components to access the Internet) in accordance with an aspect of the present disclosure. For example, UE 415 may include a bearer communicating component 640 for determining prioritization of multiple bearers (e.g., split and/or network entity specific bearers) over one or more data paths 445, 450 with one or more access points (e.g., eNB 405, AP 406, etc.) in mapping data thereto, as described further herein in FIG. 6. The data paths 445, 450 are shown within the context of a wireless communications system 400 for aggregating data from different radio access technologies. The system 300 of FIG. 3 may be an example of portions of the wireless communications system 400. The wireless communications system 400 may include a multi-mode UE 415, an eNodeB 405, a WLAN AP 406, an evolved packet core (EPC) 480, a PDN 440, and a peer entity 455. The multi-mode UE 415 may be configured to support multiple connectivity (e.g., dual connectivity) carrier aggregation. The EPC 480 may include a mobility management entity (MME) 430, a serving gateway (SGW) 432, and a PDN gateway (PGW) 434. A home subscriber system (HSS) 435 may be communicatively coupled with the MME 430. The UE 415 may include an LTE radio 420 and a WLAN radio 425. These elements may represent aspects of one or more of their counterparts described above with reference to the previous or subsequent Figures. For example, the UE 415 may be an example of UEs in FIG. 1, FIG. 2, FIG. 3, FIG. 4b, FIG. 5, FIG. 6, processing system 1014 in FIG. 10, etc., the eNodeB 405 may be an example of the eNodeBs/base stations of FIG. 1, FIG. 2, FIG. 3, FIG. 5, FIG. 4b, FIG. 6, the AP 406 may be an example of the AP of FIG. 3, and/or the EPC 480 may be an example of the core network of FIG. 1. The eNodeB 405 and AP 406 in FIG. 4a may be not be collocated or otherwise may not be in high-speed communication with each other.

Referring back to FIG. 4a, the eNodeB 405 and the AP 406 may be capable of providing the UE 415 with access to the PDN 440 using the aggregation of one or more LTE component carriers or one or more WLAN component carriers. Accordingly, the UE 415 may involve carrier aggregation in dual connectivity, where one connection is to one network entity (eNodeB 405) and the other connection is to a different network entity (AP 406 or another eNodeB, not shown). Using this access to the PDN 440, the UE 415 may communicate with the peer entity 455. The eNodeB 405 may provide access to the PDN 440 through the evolved packet core 480 (e.g., through data path 445), and the WLAN AP 406 may provide direct access to the PDN 440 (e.g., through data path 450).

The MME 430 may be the control node that processes the signaling between the UE 415 and the EPC 480. Generally, the MME 430 may provide bearer and connection management. The MME 430 may, therefore, be responsible for idle mode UE tracking and paging, bearer activation and deactivation, and SGW selection for the UE 415. The MME 430 may communicate with the eNodeB 405 over an S1-MME interface. The MME 430 may additionally authenticate the UE 415 and implement Non-Access Stratum (NAS) signaling with the UE 415.

The HSS 435 may, among other functions, store subscriber data, manage roaming restrictions, manage accessible access point names (APNs) for a subscriber, and associate subscribers with MMEs 430. The HSS 435 may communicate with the MME 430 over an Sha interface defined by the Evolved Packet System (EPS) architecture standardized by the 3GPP organization.

All user IP packets transmitted over LTE may be transferred through eNodeB 405 to the SGW 432, which may be connected to the PDN gateway 434 over an S5 signaling interface and the MME 430 over an S11 signaling interface. The SGW 432 may reside in the user plane and act as a mobility anchor for inter-eNodeB handovers and handovers between different access technologies. The PDN gateway 434 may provide UE IP address allocation as well as other functions.

The PDN gateway 434 may provide connectivity to one or more external packet data networks, such as PDN 440, over an SGi signaling interface. The PDN 440 may include the Internet, an Intranet, an IP Multimedia Subsystem (IMS), a Packet-Switched (PS) Streaming Service (PSS), and/or other types of PDNs.

In the present example, user plane data between the UE 415 and the EPC 480 may traverse the same set of one or more EPS bearers, irrespective of whether the traffic flows over path 445 of the LTE link or path 450 of the WLAN link. Signaling or control plane data related to the set of one or more EPS bearers may be transmitted between the LTE radio 420 of the UE 415 and the MME 430 of the EPC 480, by way of the eNodeB 405.

While aspects of FIG. 4a have been described with respect to LTE, similar aspects regarding aggregation and/or multiple connections may also be implemented with respect to UMTS or other similar system or network wireless communications radio technologies.

FIG. 4b is a block diagram conceptually illustrating an example of data paths 445-a and 445-b between the UE 415 and the EPC 480 in accordance with an aspect of the present disclosure. For example, UE 415 may include a bearer communicating component 640 for determining prioritization of multiple bearers (e.g., split and/or network entity specific bearers) over one or more data paths 445-a, 445-b with one or more access points (e.g., eNB 405-a, 405-b, etc.) in mapping data thereto, as described further herein in FIG. 6. The data paths 445-a, 445-b are shown within the context of a wireless communications system 401 for aggregating data of a split bearer for transmitting using resources of multiple eNodeBs 405-a, 405-b. This can be an alternative bearer configuration to that shown in FIG. 4a, for example, having data path 445 that traverses eNodeB 405. The system 300 of FIG. 3 may be an example of portions of the wireless communications system 401. The wireless communications system 401 may include a UE 415, eNodeB 405-a, eNodeB 405-b, an evolved packet core (EPC) 480, a PDN 440, and a peer entity 455. The UE 415 may be configured to support multiple connectivity (e.g., dual connectivity) carrier aggregation. It is to be appreciated that the UE 415 can be a multi-mode UE that can communicate with eNodeBs 405-a and 405-b along with a WLAN AP, as shown in FIG. 4a, however, such components may be omitted for ease of explanation. The EPC 480 may include a mobility management entity (MME) 430, a serving gateway (SGW) 432, and a PDN gateway (PGW) 434. A home subscriber system (HSS) 435 may be communicatively coupled with the MME 430. The UE 415 may include an LTE radio 420. These elements may represent aspects of one or more of their counterparts described above with reference to the previous or subsequent Figures. For example, the UE 415 may be an example of UEs in FIG. 1, FIG. 2, FIG. 3, FIG. 4a, FIG. 5, FIG. 6, processing system 1014 of FIG. 10, etc., the eNodeB 405-a may be an example of the eNodeBs/base stations of FIG. 1, FIG. 2, FIG. 3, FIG. 4a, FIG. 5, FIG. 6, and/or the EPC 480 may be an example of the core network of FIG. 1. The eNodeB 405-a and eNodeB 405-b in FIG. 4b may not be collocated.

Referring back to FIG. 4b, the eNodeB 405-a and the eNodeB 405-b may be capable of providing the UE 415 with access to the PDN 440 over separate uplink resource grants, which may relate to one or more LTE component carriers, as described. Accordingly, the UE 415 may involve carrier aggregation in dual connectivity, where one connection is to one network entity (eNodeB 405-a) and the other connection is to a different network entity (eNodeB 405-b). Using this access to the PDN 440, the UE 415 may communicate with the peer entity 455. UE 415 can establish a split bearer that uses connections with eNodeB 405-a and eNodeB 405-b to access the PDN 440 through the evolved packet core 480. In the depicted example, the split bearer is provided in coordination with the eNodeB 405-a as a MeNodeB and the eNodeB 405-b as SeNodeB. As described, for example, eNodeB 504-a may manage the split bearer at a PDCP layer to coordinate communicating over separate RLC/MAC and/or other layers via eNodeB 405-a and eNodeB 405-b. Thus, for example, the eNodeBs 405-a and 405-b can communicate with one another to aggregate UE 415 communications for providing the EPC 480. In this example, UE 415 can access the PDN 440 by using the split bearer, which can map communications over the data paths 445-a and 445-b to access the PDN 440.

The MME 430 may be the control node that processes the signaling between the UE 415 and the EPC 480, as described. Generally, the MME 430 may provide bearer and connection management for establishing and managing connectivity of the split bearer. The MME 430 may, therefore, be responsible for idle mode UE tracking and paging, bearer activation and deactivation, and SGW selection for the UE 415. The MME 430 may communicate with the eNodeBs 405-a and 405-b over an S1-MME interface. The MME 430 may additionally authenticate the UE 415 and implement Non-Access Stratum (NAS) signaling with the UE 415, as described.

All user IP packets transmitted over LTE may be transferred through eNodeB 405-a or eNodeB 405-b to the SGW 432, which may be connected to the PDN gateway 434 over an S5 signaling interface and the MME 430 over an S11 signaling interface. In one example, as shown, the MME 430 can aggregate data received over the data paths 445-a and 445-b based on the data being associated with the same split bearer, and can provide the aggregated data on to the SGW 432 for further processing.

Thus, in the present example, user plane data between the UE 415 and the EPC 480 may traverse the split bearer, which may be an EPS bearer, over resources granted by one or more of the eNodeB 405-a and 405-b. Signaling or control plane data related to the set of one or more EPS bearers may be transmitted between the LTE radio 420 of the UE 415 and the MME 430 of the EPC 480, by way of the eNodeB 405-a or eNodeB 405-b, and may include eNodeB specific control plane data or bearer related control plane data.

While aspects of FIG. 4b have been described with respect to LTE, similar aspects regarding aggregation and/or multiple connections may also be implemented with respect to UMTS or other similar system or network wireless communications radio technologies.

FIG. 5 is a diagram conceptually illustrating multiple connectivity carrier aggregation in accordance with an aspect of the present disclosure. A wireless communications system 500 may include a master eNodeB 505-a (MeNodeB or MeNB) having a set or group of cells referred to as a master cell group or MCG that may be configured to serve the UE 515. For example, UE 515 may include a bearer communicating component 640 for determining prioritization of multiple bearers (e.g., split and/or network entity specific bearers) related to one or more CCs with one or more access points (e.g., MeNodeB 505-a, SeNodeB 505-b, etc.) in mapping data thereto, as described further herein in FIG. 6. The MCG may include one primary cell (PCell_{MCG}) 510-a and one or more secondary cells 510-b (only one is shown). The wireless communications system 500 may also include a secondary eNodeB 505-b (SeNodeB or SeNB) having a set or group of cells referred to as a secondary cell group or SCG that may be configured to serve the UE 515. The SCG may include one primary cell (PCell_{SCG}) 512-a and one or more secondary cells 512-b (only one is shown). Also shown is a UE 515 that supports carrier aggregation for multiple connectivity (e.g., dual connectivity). The UE 515 may communicate with the MeNodeB 505-a via communication link 525-a and with the SeNodeB 505-b via communication link 525-b.

In an example, the UE 515 may aggregate component carriers from the same eNodeB or may aggregate component carriers from collocated or non-collocated eNodeBs. In such an example, the various cells (e.g., different component carriers (CCs)) being used can be easily coordinated because they are either handled by the same eNodeB or by eNodeBs that can communicate control information. When the UE 515, as in the example of FIG. 5, performs carrier aggregation when in communication with two eNodeBs that are non-collocated, then the carrier aggregation operation may be different due to various network conditions. In this case, establishing a primary cell (PCell_{SCG}) in the secondary eNodeB 505-b may allow for appropriate configurations and controls to take place at the UE 515 even though the secondary eNodeB 505-b is non-collocated with the primary eNodeB 505-a.

In the example of FIG. 5, the carrier aggregation may involve certain functionalities by the PCell of the MeNodeB 505-a. For example, the PCell may handle certain functionalities such as physical uplink control channel (PUCCH), contention-based random access control channel (RACH), and semi-persistent scheduling to name a few. Carrier aggregation with dual or multiple connectivity to non-collocated eNodeBs may involve having to make some enhancements and/or modifications to the manner in which carrier aggregation is otherwise performed. Some of the enhancements and/or modifications may involve having the UE 515 connected to the MeNodeB 505-a and to the SeNodeB 505-b as described above. Other features may include, for example, having a timer adjustment group (TAG) comprise cells of one of the eNodeBs, having contention-based and contention-free random access (RA) allowed on the SeNodeB 505-b, separate discontinuous reception (DRX) procedures for the MeNodeB 505-a and to the SeNodeB 505-b, having the UE 515 send a buffer status report (BSR) to the eNodeB where the one or more bearers (e.g., eNodeB specific or split bearers) are served, as well as enabling one or more of power headroom report (PHR), power control, semi-persistent scheduling (SPS), and logical channel prioritization in connection with the PCell_{SCG} in the secondary eNodeB 505-b. The enhancements and/or modifications described above, and well as others provided in the disclosure, are intended for purposes of illustration and not of limitation.

For carrier aggregation in dual connectivity, different functionalities may be divided between the MeNodeB 505-a and the SeNodeB 505-b. For example, different functionalities may be statically divided between the MeNodeB 505-a and the SeNodeB 505-b or dynamically divided between the MeNodeB 505-a and the SeNodeB 505-b based on one or more network parameters. In an example, the MeNodeB 505-a may perform upper layer (e.g., above the media access control (MAC) layer) functionality via a PCell, such as but not limited to functionality with respect to initial configuration, security, system information, and/or radio link failure (RLF). As described in the example of FIG. 5, the PCell may be configured as one of the cells of the MeNodeB 505-a that belong to the MCG. The PCell may be configured to provide lower layer functionalities (e.g., MAC/PHY layer) within the MCG.

In an example, the SeNodeB 505-b may provide configuration information of lower layer functionalities (e.g., MAC/PHY layers) for the SCG. The configuration information may be provided by the PCell_{SCG} as one or more radio resource control (RRC) messages, for example. The PCell_{SCG} may be configured to have the lowest cell index (e.g., identifier or ID) among the cells in the SCG. For example, some of the functionalities performed by the SeNodeB 505-b via the PCell_{SCG} may include carrying the PUCCH, configuring the cells in the SCG to follow the DRX configuration of the PCell_{SCG}, configuring resources for contention-based and contention-free random access on the SeNodeB 505-b, carrying downlink (DL) grants having transmit power control (TPC) commands for PUCCH, estimating pathloss based on PCell_{SCG} for other cells in the SCG, providing common search space for the SCG, and providing SPS configuration information for the UE 515.

In some aspects, the PCell may be configured to provide upper level functionalities to the UE 515 such as security, connection to a network, initial connection, and/or radio link failure, for example. The PCell may be configured to carry PUCCH for cells in the MCG, to include the lowest cell index among the MCG, to enable the MCG cells to have the same DRX configuration, to configure random access resources for one or both of contention-based and contention-free random access on the MeNodeB 505-a, to enable downlink grants to convey TPC commands for PUCCH, to enable pathloss estimation for cells in the MCG, to configure common search space for the MeNodeB 505-a, and/or to configure SPS.

In some aspects, the PCell_{SCG} may be configured to carry PUCCH for cells in the SCG, to include the lowest cell index among the SCG, to enable the SCG cells to have the same DRX configuration, to configure random access resources for one or both of contention-based and contention-free random access on the SeNodeB 505-b, to enable downlink grants to convey TPC commands for PUCCH, to enable pathloss estimation for cells in the SCG, to configure common search space for the SeNodeB 505-b, and/or to configure semi-persistent scheduling.

Returning to the example of FIG. 5, the UE 515 may support parallel PUCCH and PUSCH configurations for the MeNodeB 505-a and the SeNodeB 505-b. In some cases, the UE 515 may use a configuration (e.g., UE 515 based) that may be applicable to both carrier groups. These PUCCH/PUSCH configurations may be provided through RRC messages, for example.

The UE 515 may also support parallel configuration for simultaneous transmission of acknowledgement (ACK)/negative acknowledgement (NACK) and channel quality indicator (CQI) and for ACK/NACK/sounding reference signal (SRS) for the MeNodeB 505-a and the SeNodeB 505-b. In some cases, the UE 515 may use a configuration (e.g., UE based and/or MCG or SCG based) that may be applicable to both carrier groups. These configurations may be provided through RRC messages, for example.

FIG. 6 is a block diagram 600 conceptually illustrating an example of a UE 615 and components configured in accordance with an aspect of the present disclosure. FIGS. 7-9, which are described in conjunction with FIG. 6 herein, illustrate example methods 700, 800, 900 in accordance with aspects of the present disclosure. Although the operations described below in FIGS. 7-9 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

Referring to FIG. 6, a base station/eNodeB 605-a (MeNodeB with a PCell), a base station/eNodeB 605-b (SeNodeB with a PCell_{SCG}), and the UE 615 of diagram 600 may be one of the base stations/eNodeBs (or APs) and UEs as described in various Figures above (e.g., FIG. 1, 2, 3, 4a, 4b, 5, etc.), processing system 1014 in FIG. 10, etc. The MeNodeB 605-a and the UE 615 may communicate over communication link 625-a. The SeNodeB 605-b and the UE 615 may communicate over communication link 625-b. Each of the communication links 625-a, 625-b may be an example of the communication links 125 of FIG. 1. In addition, for example, UE 615 can utilize at least one split bearer for communicating with a wireless network using resources of MeNodeB 605-a and SeNodeB 605-b, as well as at least one eNodeB-specific bearer for communicating with the wireless network using resources of MeNodeB 605-a. As described, for example, MeNodeB 605-a (e.g., at a PDCP layer) may control communications using the split bearer such that communications received over communication link 625-b (e.g. at MAC/RLC layers) are provided to MeNodeB 605-a for processing along with communications received over communication link 625-a.

In this regard, UE 615 may include a bearer communicating component 640 to manage bearer prioritization and data mapping for communications over the various bearers between UE 615 and MeNodeB 605-a and/or SeNodeB 605-b to ensure that each of the bearers has an opportunity to transmit data using resources configured by MeNodeB 605-a and/or SeNodeB 605-b. For example, bearer communicating component 640 can perform Blocks illustrated and described in method 700 and/or 800 and/or additional functions in this regard. Though shown and described as pertaining to a split bearer having a higher priority than an eNodeB-specific bearer, it is to be appreciated that the concepts can be applied to substantially any bearers having varying priorities such that bearer communicating component 640 manages communications over the bearers to ensure that the lower priority bearer is provided at least some opportunity to transmit.

Referring to FIG. 7, method 700 includes, at Block 710, mapping a first portion of first data available for transmission over a first type bearer to first uplink resources granted from a first base station. Bearer communicating component 640 (FIG. 6) includes a split bearer data mapping component 650 for mapping the first portion of data for transmission over the first type bearer (e.g. a split bearer) to first uplink resources granted from the first base station (e.g., MeNodeB 605-a). The mapping of data can occur over a logical channel related to the resources provided by the MeNodeB 605-a. For example, mapping data can include assigning media access control (MAC) layer data units to certain time/frequency resources for modulation and transmission over one or more transmit antennas. In addition, for example, split bearer data mapping component 650 includes a fraction bearer data selecting component 652 for selecting a fraction of the data available for transmitting over the split bearer (e.g., instead of all data available). In this regard, split bearer data mapping component 650 can map the fraction of data (e.g., not all of the data for the split bearer) over uplink resources for MeNodeB 605-a, and may allow mapping data for the eNodeB-specific bearer to MeNodeB 605-a over at least a portion of the remaining uplink resources as well, as described in further detail below.

Bearer communicating component 640 can also include MeNodeB UL resource utilizing component 680 for providing an indication of a grant of uplink resources to the split bearer data mapping component 650 for facilitating the mapping and/or for transmitting data as mapped to the UL resources to the MeNodeB 605-a (e.g., over link 625-a). Bearer communicating component 640 can also include a SeNodeB UL resource utilizing component 690 for providing an indication of a grant of uplink resources to the split bearer data mapping component 650 for facilitating mapping and/or for transmitting data over UL resources to the SeNodeB 605-b (e.g., over link 625-b), as described further herein.

In one example, split bearer data mapping component 650 can optionally include a token bucket managing component 654 that utilizes a token bucket operation for providing one or more “token buckets” for mapping split bearer data to the uplink resources (e.g., to ensure QoS for the split bearer). For example, token bucket operations typically allow for continually generating tokens in a virtual token bucket at a rate related to providing a certain QoS, and thus token buckets can generally correlate to a given bearer. Tokens are also removed from the virtual token bucket as data is transmitted (e.g., data is correlated with a token that is removed from the virtual token bucket when the data is transmitted). When available tokens are insufficient for a given transmission, this can indicate that transmission is occurring at a higher rate than the intended QoS, and the transmission can be delayed until additional tokens are generated according to the QoS. In one example, these token buckets can be employed at the MAC layer to manage QoS for data transmission.

In this regard, token bucket managing component 654 can generate and remove (or utilize) tokens for one or more token buckets, as described below. In one example, the token bucket managing component 654 includes a common token bucket 656 for the split bearer such that split bearer data mapping component 650 can utilize tokens from the common token bucket 656 for mapping split bearer data over MeNodeB UL resources and/or SeNodeB UL resources. In another example, token bucket managing component 654 includes separate token buckets for each eNodeB relating to the split bearer, which in this example includes MeNodeB token bucket 658 and SeNodeB token bucket 659, such that token bucket managing component 654 removes tokens from MeNodeB token bucket 658 based on mapping split bearer data over MeNodeB UL resources and/or removes tokens from SeNodeB token bucket 659 based on mapping split bearer data over SeNodeB UL resources.

The example in method 800 illustrates an example of using token buckets to map bearer data to uplink resources. Method 800 includes, at Block 810, determining a first portion of first data available for transmission over a split bearer for mapping to uplink resources granted from a first base station based at least in part on a fraction of available tokens available in a token bucket for the split bearer. Fractional bearer data selecting component 652 can determine the first portion of first data available for transmission over the split bearer for mapping to uplink resources granted from the first base station (e.g. MeNodeB 605-a) based at least in part on the fraction of tokens available in a token bucket for the split bearer (e.g., the common token bucket 656 or MeNodeB token bucket 658). Thus, whether a common token bucket or separate token buckets are used, fractional bearer data selecting component 652 can utilize a fraction of tokens available in one or more of the token buckets for mapping split bearer data to one or more of the eNodeBs 605-a or 605-b. For example, where token bucket managing component 654 includes a common token bucket 656 for the split bearer, fractional bearer data selecting component 652 can utilize a fraction of tokens available in the common token bucket 656 in mapping split bearer data to UL resources of MeNodeB 605-a (e.g., resources as indicated by MeNodeB UL resource utilizing component 680). Where token bucket managing component 654 includes a separate MeNodeB token bucket 658 and SeNodeB token bucket 659, for example, fractional bearer data selecting component 652 can utilize a fraction of tokens available in the MeNodeB token bucket 658 in mapping split bearer data to uplink resources of MeNodeB 605-a.

In this example, fractional bearer data selecting component 652 may determine that the UE 615 is operating using multiple- or dual-connectivity and/or that the UE 615 has an eNodeB-specific bearer with the MeNodeB 605-a, and can accordingly limit the data mapped to UL resources of the MeNodeB 605-a, as described, based on fractional bearer data selecting component 652 determining the first portion of first data available for transmission over the split bearer based at least in part on the fraction of tokens available in a token bucket for the split bearer. Though not described in detail, it is to be appreciated that the fractional bearer data selecting component 652 can similarly limit data mapped to other resources based on determining that the resources are shared by one or more bearers (e.g., where one bearer is a split bearer or otherwise).

Referring again to FIG. 7, method 700 also includes, at Block 712, determining whether a remaining portion of the first uplink resources are still available, and if so, at Block 714, mapping second data from a second type bearer to at least a first portion of the remaining portion of the first uplink resources based at least in part on determining that the remaining portion of the first uplink resources are available. Bearer communicating component 640 includes an eNodeB-specific bearer data mapping component 660 for determining whether the remaining portion of the first uplink resources (e.g., resources related to MeNodeB 605-a) are available, and if so, for mapping second data from the second type bearer (e.g., the eNodeB-specific bearer) to at least the first portion of the remaining portion of the first uplink resources. Thus, by initially mapping a fraction of split bearer data on the MeNodeB 605-a uplink resources (e.g., in Block 710, 810, etc.), this may increase the chance that MeNodeB 605-a uplink resources are also available for data related to the eNodeB-specific bearer, which may be of a lower priority than the split bearer.

Referring to the specific example of using token buckets to map bearer data to uplink resources, method 800 includes, at Block 812, determining second data available for transmission over a base station specific bearer for mapping to at least a portion of remaining uplink resources granted from the first base station based at least in part on tokens available in a token bucket for the base station specific bearer. eNodeB-specific bearer data mapping component 660 can determine the second data available for transmission over the base station specific bearer for mapping to at least the portion of remaining uplink resources granted from the first base station based at least in part on tokens available in the token bucket for the base station specific bearer. In this regard, for example, eNodeB-specific bearer data mapping component 660 may optionally include a token bucket managing component 662 for utilizing tokens available in a token bucket (not explicitly depicted) for the eNodeB-specific bearer in mapping data from the eNodeB-specific bearer to uplink resources of MeNodeB 605-a (e.g., resources as specified by MeNodeB UL resource utilizing component 680). In an example, token bucket managing component 662 can map all available data for the eNodeB-specific bearer using the available tokens (e.g., all data in a related buffer). In some examples, additional uplink resources of the MeNodeB 605-a may remain after mapping the eNodeB-specific bearer data as well. In any case, this can ensure that at least some resources are reserved for transmitting the eNodeB-specific data.

Referring again to FIG. 7, method 700 optionally includes, at Block 716, determining whether an additional remaining portion of the first uplink resources are still available after mapping the second data on the resources, and if so, at Block 718, mapping a second portion of the first data available for transmission over the first type bearer to the first uplink resources based at least in part on determining that the additional remaining resources of the first uplink resources are available. For example, split bearer data mapping component 650 can determine whether the additional remaining portion of the first uplink resources (e.g., MeNodeB 605-a UL resources) are available after eNodeB-specific bearer data mapping component 660 maps the second data on the MeNodeB 605-a UL resources, and can accordingly map the second portion of the first data available for transmission over the first type bearer (e.g., the split bearer) to the first uplink resources (e.g., the remaining MeNodeB 605-a UL resources).

Similarly, in the specific example employing token buckets, method 800 optionally includes, at Block 814, determining a second portion of the first data for mapping to another portion of the remaining uplink resources granted from the first base station based at least in part on utilizing another fraction of tokens available in the token bucket for the split bearer. For example, split bearer data mapping component 650 can determine the second portion of the first data for mapping to another portion of the remaining uplink resources (e.g., MeNodeB 605-a UL resources) granted from the first base station based at least in part on utilizing another fraction of tokens available in the token bucket for the split bearer (e.g., common token bucket 656 or MeNodeB token bucket 658). Thus, where MeNodeB 605-a UL resources remain, token bucket managing component 654 can use another portion of tokens in the common token bucket 656 for the split bearer, or from the MeNodeB token bucket 658 where separate token buckets are used, in mapping the data to the MeNodeB 605-a UL resources.

Moreover, as described, split bearer data mapping component 650 may also map split bearer data for transmission over SeNodeB 605-b UL resources. Thus, for example, split bearer data mapping component 650 can also receive UL grant information relating to the SeNodeB 605-b (e.g., via SeNodeB UL resource utilizing component 690) and can map a portion of the data for the split bearer to SeNodeB 605-b UL resources instead. Where split bearer data mapping component 650 utilizes token buckets, for example, token bucket managing component 654 can utilize tokens from the common token bucket 656 or from the SeNodeB token bucket 659, depending on the token bucket configuration, in mapping the data to the SeNodeB UL resources in providing the QoS for the split bearer. Thus, in an example, where sufficient resources are not available with the MeNodeB 605-a to transmit split bearer data because a portion of the MeNodeB 605-a resources are used to map eNodeB-specific data, split bearer data mapping component 650 can map additional split bearer data to the SeNodeB 605-b resources.

Additionally, though shown with respect to a single split bearer and a single eNodeB-specific bearer, it is to be appreciated that aspects described herein can be similarly applied to multiple split bearers and/or multiple eNodeB-specific bearers. In one example, UE 615 may include a separate split bearer data mapping component 650 or eNodeB-specific bearer data mapping component 660 for each bearer.

In one example, fractional bearer data selecting component 652 may determine the fraction of split bearer data to map to the MeNodeB 605-a UL resources or a number of tokens for mapping the data (e.g., as in Blocks 710, 810, etc.) based at least in part on a buffer fraction reported in a BSR for the split bearer. For example, where the buffer for the split bearer is indicated as 60% utilized, fractional bearer data selecting component 652 may determine the fraction of split bearer data to map to the MeNodeB 605-a UL resources as 60% of the data in the buffer and/or as some percentage determined as a function or range based on the reported 60% buffer utilization. In addition, for example, fractional bearer data selecting component 652 may determine the fraction of tokens for mapping the split bearer data based at least in part on reserving a minimum amount of tokens to transmit eNodeB-specific information of MeNodeB 605-a (e.g., radio link control (RLC) reports) over the MeNodeB 605-a UL resources along with the split bearer data.

In another example, fractional bearer data selecting component 652 may operate to select the fraction of data or tokens (e.g., at Blocks 710, 810, etc.) based on determining that a level of tokens in the token bucket for the eNodeB-specific bearer achieves or exceeds a threshold level. For instance, fractional bearer data selecting component 652 can query eNodeB-specific bearer data mapping component 660 to obtain the level of tokens in the token bucket managed by token bucket managing component 662. Determining that the level of tokens is above a threshold (e.g., as an outright comparison or based on a historical level averaged over a period of time) may indicate that the eNodeB-specific bearer is not providing at least a QoS related to the token buckets (e.g., tokens are coming in but not going out of the token bucket at a desired rate). In this regard, fractional bearer data selecting component 652 can limit split bearer data for transmitting over the MeNodeB 605-a UL resources to a fraction of the available data based on this determination, as described, to allow for mapping at least some of the data for the eNodeB-specific bearer to the MeNodeB 605-a UL resources. Moreover, it is to be appreciated, in an example, that fractional bearer data selecting component 652 may further select the fraction of data or tokens (e.g., at Blocks 710, 810, etc.) based at least in part on a number of tokens in the token bucket for the eNodeB-specific bearer.

In further examples, where token bucket managing component 654 uses a common token bucket 656 for providing the QoS for the split bearer over MeNodeB 605-a and SeNodeB 605-b, fractional bearer data selecting component 652 can determine the fraction of data or tokens (e.g., at Block 710, 810, etc.) for mapping based at least in part on an achievable or otherwise measured throughput of link 625-a and/or link 625-b. As described, the tokens in common token bucket 656 can be generated by UE 615 (e.g., by token bucket managing component 654) for providing a QoS for the split bearer. For example, fractional bearer data selecting component 652 can determine a ratio of the link throughput of the links 625-a and 625-b, and can select the fraction of data or tokens for mapping over a given link based on the ratio. For example, fractional bearer data selecting component 652 can select a ratio of the data or tokens for mapping on MeNodeB 605-a UL resources as N:1, where fractional bearer data selecting component 652 determines link 625-a is N times faster than link 625-b. In another example, using a common token bucket 656, fractional bearer data selecting component 652 can determine the fraction of data or tokens (e.g., at Blocks 710, 810, etc.) based on comparing BSR ratio related to the MeNodeB 605-a versus a BSR ratio related to the SeNodeB 605-b (e.g., fractional bearer data selecting component 652 can determine the fraction of data or tokens for mapping over MeNodeB 605-a UL resources as a percentage related to a percentage of BSR configured for MeNodeB 605-a). Furthermore, for example, fractional bearer data selecting component 652 can determine the fraction of data or tokens (e.g., at Blocks 710, 810, etc.) based on data that is reported in BSR (e.g., fractional bearer data selecting component 652 can determine the fraction of data or tokens for mapping over MeNodeB 605-a UL resources based on RLC or PDCP data for MeNodeB 605-a).

In any case, method 700 can also include, at Block 720, transmitting the first portion of the first data, the second data, and/or the second portion of the first data over the first type bearer or the second type bearer. Bearer communicating component 640 can transmit the first portion of the first data, the second data, and/or the second portion of the first data over the first type bearer or the second type bearer (e.g., the split bearer and/or eNodeB-specific bearer). This can be based on the determined mappings described above, as performed by split bearer data mapping component 650, eNodeB-specific bearer data mapping component 660, etc.

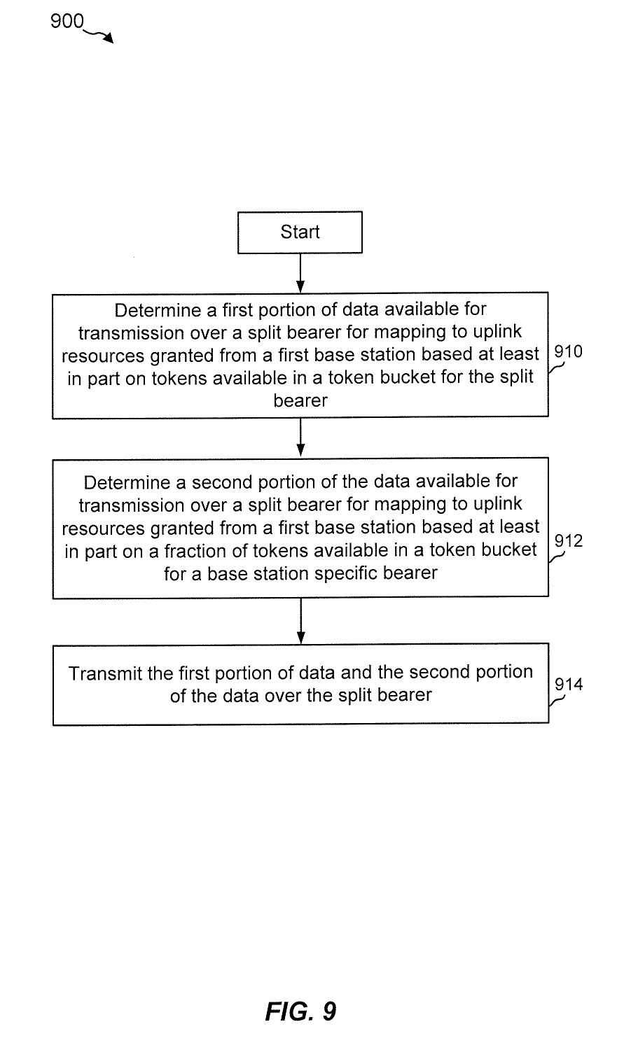

In addition, in some examples, where token bucket managing component 654 uses a separate MeNodeB token bucket 658 and SeNodeB token bucket 659 for providing the QoS for the split bearer over MeNodeB 605-a and SeNodeB 605-b, token bucket managing component 654 may utilize tokens in a token bucket for a first link when mapping data over resources of the other link. This, in a sense, may be similar to providing a common token bucket. For example, split bearer data mapping component 650 may map data from the split bearer onto uplink resources of MeNodeB 605-a, but may utilize tokens from the SeNodeB token bucket 659, and/or vice versa in performing the mapping. In an example, token bucket managing component 654 can implement this functionality once the data from the eNodeB-specific bearer is mapped to MeNodeB 605-a UL resources to allow for transmitting additional split bearer data where MeNodeB 605-a UL resources remain. This allows for better tracking of QoS via the token bucket mechanism even though the additional data is being mapped to MeNodeB 605-a instead of SeNodeB 605-b. In using tokens from the SeNodeB token bucket 659, however, token bucket managing component 654 can ensure a minimum amount of tokens remain for mapping (and transmitting) SeNodeB 605-b specific data, such as RLC reports, over the SeNodeB 605-b UL resources via SeNodeB UL resource utilizing component 690. This is described in reference to FIG. 9.

FIG. 9 illustrates a method 900 for utilizing a split bearer token bucket and a eNodeB-specific bearer token bucket for mapping data to a split bearer. Method 900 includes, at Block 910, determining a first portion of data available for transmission over a split bearer for mapping to uplink resources granted from a first base station based at least in part on tokens available in a token bucket for the split bearer. For example, split bearer data mapping component 650 may determine the first portion of data available for transmission over the split bearer for mapping to uplink resources granted from the first base station (e.g., MeNodeB 605-a UL resources) based at least in part on the tokens available in the token bucket for the split bearer (e.g., common token bucket 656 or MeNodeB token bucket 658). In an example, data may remain after being mapped to available tokens for the split bearer.

Thus, method 900 includes, at Block 912, determining a second portion of the data available for transmission over a split bearer for mapping to uplink resources granted from a first base station based at least in part on a fraction of tokens available in a token bucket for a base station specific bearer. Split bearer data mapping component 650 may determine the second portion of data available for transmission over the split bearer for mapping to uplink resources granted from the first base station (e.g., MeNodeB 605-a UL resources) based at least in part on the tokens available in the token bucket for the base station specific bearer (e.g., a token bucket for an eNodeB-specific data bearer managed by token bucket managing component 662). Accordingly, split bearer data mapping component 650 can utilize tokens from the token bucket managed by token bucket managing component 662 for transmitting the split bearer data over MeNodeB 605-a UL resources. In so doing, however, split bearer data mapping component 650 can ensure token bucket managing component 662 retains at least a minimum number of tokens for transmitting eNodeB-specific data, such as RLC reports, etc.

Method 900 further includes, at Block 914, transmitting the first portion of data and the second portion of the data over the split bearer. Bearer communicating component 640 can transmit the first portion of the data and the second portion of the data over the split bearer.

FIG. 10 is a block diagram conceptually illustrating an example hardware implementation for an apparatus 1000 employing a processing system 1014 configured in accordance with an aspect of the present disclosure. The processing system 1014 includes a bearer communicating component 640. In one example, the apparatus 1000 may be the same or similar, or may be included with one of the UEs described in various Figures. In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 links together various circuits including one or more processors (e.g., central processing units (CPUs), microcontrollers, application specific integrated circuits (ASICs), field programmable gate arrays (FPGAs)) represented generally by the processor 1004, and computer-readable media, represented generally by the computer-readable medium 1006. The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010, which is connected to one or more antennas 1020 for receiving or transmitting signals. The transceiver 1010 and the one or more antennas 1020 provide a mechanism for communicating with various other apparatus over a transmission medium (e.g., over-the-air). Depending upon the nature of the apparatus, a user interface (UI) 1012 (e.g., keypad, display, speaker, microphone, joystick) may also be provided.

The processor 1004 is responsible for managing the bus 1002 and general processing, including the execution of software stored on the computer-readable medium 1006. The software, when executed by the processor 1004, causes the processing system 1014 to perform the various functions described herein for any particular apparatus. The computer-readable medium 1006 may also be used for storing data that is manipulated by the processor 1004 when executing software. The bearer communicating component 640 as described above may be implemented in whole or in part by processor 1004, or by computer-readable medium 1006, or by any combination of processor 1004 and computer-readable medium 1006.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but it is to be accorded the widest scope consistent with the principles and novel features disclosed herein.

What is claimed is:

1. A method for wireless communication, comprising:
mapping a first portion of first data available for transmission over a first type bearer to first uplink resources granted from a first base station, wherein the first type bearer is configured for transmission using the first base station and a second base station;
determining whether a remaining portion of the first uplink resources are available after mapping the first portion of the first data; and
mapping second data from a second type bearer to at least a first portion of the remaining portion of the first uplink resources based at least in part on determining that the remaining portion of the first uplink resources are available.

2. The method of claim 1, further comprising:
determining whether a second remaining portion of the first uplink resources are available after mapping the second data; and
mapping a second portion of the first data available for transmission over the first type bearer to the first uplink resources based at least in part on determining that the second remaining portion of the first uplink resources are available.

3. The method of claim 1, wherein the mapping the first portion of the first data is based at least in part on utilizing a fraction of available tokens in a token bucket related to the first type bearer.

4. The method of claim 3, wherein the token bucket is a common token bucket utilized in providing a quality of service for the first type bearer over the first uplink resources of the first base station and second uplink resources of the second base station.

5. The method of claim 4, further comprising determining the fraction of available tokens based at least in part on a buffer status report fraction for the first type bearer.

6. The method of claim 4, further comprising determining the fraction of available tokens based in part on reserving a number of the available tokens for mapping base station specific data for the first base station over the first uplink resources.

7. The method of claim 4, further comprising determining the fraction of available tokens based at least in part on respective achievable throughputs over a first link with the first base station and a second link with the second base station.

8. The method of claim 3, further comprising determining the fraction of available tokens based at least in part on determining that a number of tokens in another token bucket for the second type bearer is above a threshold level.

9. The method of claim 3, further comprising a second token bucket for utilizing in mapping other data of the first type bearer to second uplink resources granted from the second base station.

10. The method of claim 9, further comprising mapping a second portion of the first data to the first uplink resources granted from the first base station based at least in part on utilizing a portion of tokens from the second token bucket.

11. The method of claim 10, wherein utilizing the portion of tokens from the second token bucket comprises ensuring a minimum number of tokens remain in the second token bucket.

12. The method of claim 10, further comprising determining to utilize the portion of tokens in the second token bucket in mapping the second portion of the first data based at least in part on mapping the second data from the second type bearer to the uplink resources granted from the first base station.

13. The method of claim 1, further comprising transmitting the first portion of the first data and the second data as mapped over the first uplink resources to the first base station.

14. The method of claim 1, wherein the first type bearer is of a higher priority than the second type bearer.

15. An apparatus for wireless communication, comprising:
a split bearer data mapping component configured to map a first portion of first data available for transmission over a first type bearer to first uplink resources granted from a first base station, wherein the first type bearer is configured for transmission using the first base station and a second base station; and
an eNodeB-specific bearer data mapping component configured to determine whether a remaining portion of the first uplink resources are available after mapping the first portion of the first data, and map second data from a second type bearer to at least a first portion of the remaining portion of the first uplink resources based at least in part on determining that the remaining portion of the first uplink resources are available.

16. The apparatus of claim 15, wherein the split bearer data mapping component is further configured to determine whether a second remaining portion of the first uplink resources are available after mapping the second data, and map a second portion of the first data available for transmission over the first type bearer to the first uplink resources based at least in part on determining that the second remaining portion of the first uplink resources are available.

17. The apparatus of claim 15, wherein the split bearer data mapping component is configured to map the first portion of the first data based at least in part on utilizing a fraction of available tokens in a token bucket related to the first type bearer.

18. The apparatus of claim 17, wherein the token bucket is a common token bucket utilized in providing a quality of service for the first type bearer over the first uplink resources of the first base station and second uplink resources of the second base station.

19. The apparatus of claim 18, wherein the split bearer data mapping component is configured to determine the fraction of available tokens based at least in part on at least one of a buffer status report fraction for the first type bearer, reserving a number of the available tokens for mapping base station specific data for the first base station over the first uplink resources, or respective achievable throughputs over a first link with the first base station and a second link with the second base station.

20. The apparatus of claim 17, wherein the split bearer data mapping component is configured to determine the fraction of available tokens based at least in part on determining that a number of tokens in another token bucket for the second type bearer is above a threshold level.

21. The apparatus of claim 17, further comprising a second token bucket for utilizing in mapping other data of the first type bearer to second uplink resources granted from the second base station.

22. The apparatus of claim 21, wherein the split bearer data mapping component is configured to map a second portion of the first data to the first uplink resources granted from the first base station based at least in part on utilizing a portion of tokens from the second token bucket.

23. The apparatus of claim 22, wherein the split bearer data mapping component is configured to utilize the portion of tokens from the second token bucket at least in part by ensuring a minimum number of tokens remain in the second token bucket.

24. The apparatus of claim 22, wherein the split bearer data mapping component is configured to utilize the portion of tokens in the second token bucket in mapping the second portion of the first data based at least in part on mapping the second data from the second type bearer to the uplink resources granted from the first base station.

25. An apparatus for wireless communication, comprising:
means for mapping a first portion of first data available for transmission over a first type bearer to first uplink resources granted from a first base station, wherein the first type bearer is configured for transmission using the first base station and a second base station;
means for determining whether a remaining portion of the first uplink resources are available after mapping the first portion of the first data; and
means for mapping second data from a second type bearer to at least a first portion of the remaining portion of the first uplink resources based at least in part on determining that the remaining portion of the first uplink resources are available.

26. The apparatus of claim 25, wherein the means for determining determines whether a second remaining portion of the first uplink resources are available after mapping the second data, and the means for mapping the first portion of the first data maps a second portion of the first data available for transmission over the first type bearer to the first uplink resources based at least in part on determining that the second remaining portion of the first uplink resources are available.

27. The apparatus of claim 25, wherein the means for mapping the first portion of the first data maps the first portion of the first data based at least in part on utilizing a fraction of available tokens in a token bucket related to the first type bearer.

28. A non-transitory computer-readable storage medium comprising:
code for causing at least one computer to map a first portion of first data available for transmission over a first type bearer to first uplink resources granted from a first base station, wherein the first type bearer is configured for transmission using the first base station and a second base station;
code for causing the at least one computer to determine whether a remaining portion of the first uplink resources are available after mapping the first portion of the first data; and
code for causing the at least one computer to map second data from a second type bearer to at least a first portion of the remaining portion of the first uplink resources based at least in part on determining that the remaining portion of the first uplink resources are available.

29. The computer-readable medium of claim 28, wherein the code for causing the at least one computer to determine determines whether a second remaining portion of the first uplink resources are available after mapping the second data, and the code for causing the at least one computer to map the first portion of the first data maps a second portion of the first data available for transmission over the first type bearer to the first uplink resources based at least in part on determining that the second remaining portion of the first uplink resources are available.

30. The computer-readable medium of claim 28, wherein the code for causing the at least one computer to map the first portion of the first data maps the first portion of the first data based at least in part on utilizing a fraction of available tokens in a token bucket related to the first type bearer.
